(19) United States
(12) Patent Application Publication
(10) Pub. No.: US 2014/0316614 A1
(43) Pub. Date: Oct. 23, 2014

(54) Drone for collecting images and system for categorizing image data

(71) Applicant: David L. Newman, Highland Park, IL (US)

(72) Inventor: David L. Newman, Highland Park, IL (US)

(21) Appl. No.: 13/998,871

(22) Filed: Dec. 16, 2013

Related U.S. Application Data
(60) Provisional application No. 61/797,786, filed on Dec. 17, 2012.

(51) Int. Cl. G05D 1/04; G06Q 30/06

(52) U.S. Cl. CPC G05D 1/042; G06Q 30/0611
USPC 701/3; 701/23; 705/26.4

(57) ABSTRACT

A data collection system provides a first computer media for collecting image data, a second computer media for analyzing the image data and locating anomalies in the image data, a third computer media for linking particular image data to address data of the property where the anomaly is present and a fourth computer media for generating a list of pertinent properties having similar anomalies by address. The image data collected by an unmanned aerial vehicle or drone.

The present invention claims priority to provisional application No. 61/797,786 filed Dec. 17, 2012. The invention pertains to an unmanned aerial vehicle (UAV) or drone for gathering image data in neighborhoods and cities and recognize anomalies in order to aid businesses to monitor properties and in developing new leads for additional business, update services and contacts and automate surveillance and building inspection tasks.

### BACKGROUND

UAVs are known for providing surveillance and reconnaissance, such as US patent publication no. 2004/0196367, that is incorporated herein by reference. Most uses of UAVs have also been for military or governmental uses. Under Section 332(a) of the FAA Modernization and Reform Act of 2012, the U.S. Department of Transportation's Unmanned Aircraft Systems (UAS) Comprehensive Plan, the Federal Aviation Administration's Joint Planning and Development Office has developed a comprehensive plan under the guidance of the Next Generation Air Transportation System (NextGen). The Plan outlines the safe acceleration of the integration of civil UAS into the National Airspace System (NAS). Such NextGen system will open the door for businesses to use drones and UAVs to enhance data collection and provide better service for consumers such as according to the present invention.

### SUMMARY

The invention provides a data collection system comprising an unmanned aerial vehicle (UAV) having a micro-processor for managing control of the UAV and transmitting and receiving data and a camera, a ground station for controlling the UAV, a first computer media for collecting image data from the camera, a second computer media for analyzing image data and locating anomalies in the image data and a third computer media for linking particular image data to address data.

In an embodiment the system further comprises a fourth computer media for generating a list of pertinent properties having similar anomalies by address and wherein the address data is obtained from Google maps or other internet mapping database. In an embodiment the system wherein the anomalies consist of at least one of vegetation overgrowing power lines, defective shingles on roofs, defective asphalt on driveways, debris in gutters, defective grout on brick, defective caulking on windows, excessive heat or cool air dissipation from windows, overgrown grass, excessive leaves on ground and snow filling driveway or walkway. In an embodiment the system wherein the second computer media may calculate a particular monetary quote for corrective services to correct the anomaly based on the measured anomaly identified from the image data.

In an embodiment the system wherein the corrective service consists of at least one of removing vegetation overgrowing power lines, replacing shingles on roofs, repairing asphalt on driveways, removing debris from gutters, repairing defective grout on brick, repairing defective caulking on windows, determining amount of energy saved by replacing excessive heat or cool air dissipation from windows, mowing overgrown grass, removing excessive leaves on ground and removing snow filling driveway or walkway.

In an embodiment the system wherein the UAV is programmed to continuously provide surveillance of a group of properties over a regular period of time and to store image data for the group of properties, the image data categorized by maintenance category and analyzed to determine proper maintenance routines have been followed for a group of properties. In an embodiment the system wherein the maintenance routines are monitored by one of a landlord, municipality, insurance company, brokerage agency or government.

A further embodiment of the invention provides a data collection system comprising first computer media for collecting image data, second computer media for analyzing the image data and locating anomalies in the image data, third computer media for linking particular image data to address data of the property where the anomaly is present and fourth computer media for generating a list of pertinent properties having similar anomalies by address.

In an embodiment the system wherein the address data is obtained from Google maps or other internet mapping database. In an embodiment the system wherein the anomalies consist of at least one of vegetation overgrowing power lines, defective shingles on roofs, defective asphalt on driveways, debris in gutters, defective grout on brick, defective caulking on windows, excessive heat or cool air dissipation from windows, overgrown grass, excessive leaves on ground and snow filling driveway or walkway. In an embodiment the system wherein the second computer media may calculate a particular monetary quote for corrective services to correct the anomaly based on the measured anomaly identified from the image data.

In an embodiment the system wherein the corrective service consists of at least one of removing vegetation overgrowing power lines, replacing shingles on roofs, repairing asphalt on driveways, removing debris from gutters, repairing defective grout on brick, repairing defective caulking on windows, determining amount of energy saved by replacing excessive heat or cool air dissipation from windows, mowing overgrown grass, removing excessive leaves on ground and removing snow filling driveway or walkway.

In an embodiment the system wherein the UAV is programmed to continuously provide surveillance of a group of properties over a regular period of time and to store image data for the group of properties, the image data categorized by maintenance category and analyzed to determine proper maintenance routines have been followed for a group of properties.

Another embodiment of the invention comprising a method of collecting and classifying comprising the steps of collecting image data from an unmanned aerial vehicle (UAV), analyzing the image data and locating anomalies in the image data, linking particular image data to address data of the property where the anomaly is present and generating a list of pertinent properties having similar anomalies by address.

In an embodiment the method includes the step of calculating a particular monetary quote for corrective services to correct the anomaly based on the measured anomaly identified from the image data. In an embodiment the method provides the corrective service consists of at least one of removing vegetation overgrowing power lines, replacing shingles on roofs, repairing asphalt on driveways, removing debris from gutters, repairing defective grout on brick, repairing defective caulking on windows, determining amount of energy saved by replacing excessive heat or cool air dissipation from windows, mowing overgrown grass, removing excessive leaves on ground and removing snow filling driveway or walkway.

In an embodiment the method provides the step of programming the UAV to continuously provide surveillance of a group of properties over a regular period of time and storing image data for the group of properties, categorizing the image data by maintenance category and analyzing the image data to determine that proper maintenance routines have been followed for a group of properties.

In an embodiment the method provides the step of launching the UAV from a moving ground vehicle, providing verbal instructions to control the UAV and retrieving image data from the UAV that coordinates the itinerary and routing of the ground vehicle. In an embodiment the method wherein the ground vehicle is a cross country truck and the image data includes at least one of bridge data, traffic data, road construction data and weather data.

### BRIEF DESCRIPTION OF THE DRAWINGS

FIG. 1 is a perspective view of an unmanned aerial vehicle (UAV) of the present invention;

FIG. 2a is a screen shot of a Mission Planner Utility of the present invention;

FIG. 2b is a screen shot of a way point flight routing plan;

FIG. 3a is a perspective view of a UAV surveilling and collecting image data;

FIG. 3b is a flow diagram depicting the functional components of the UAV; and

FIG. 3c is a flow diagram of the components of a ground station.

### DETAILED DESCRIPTION

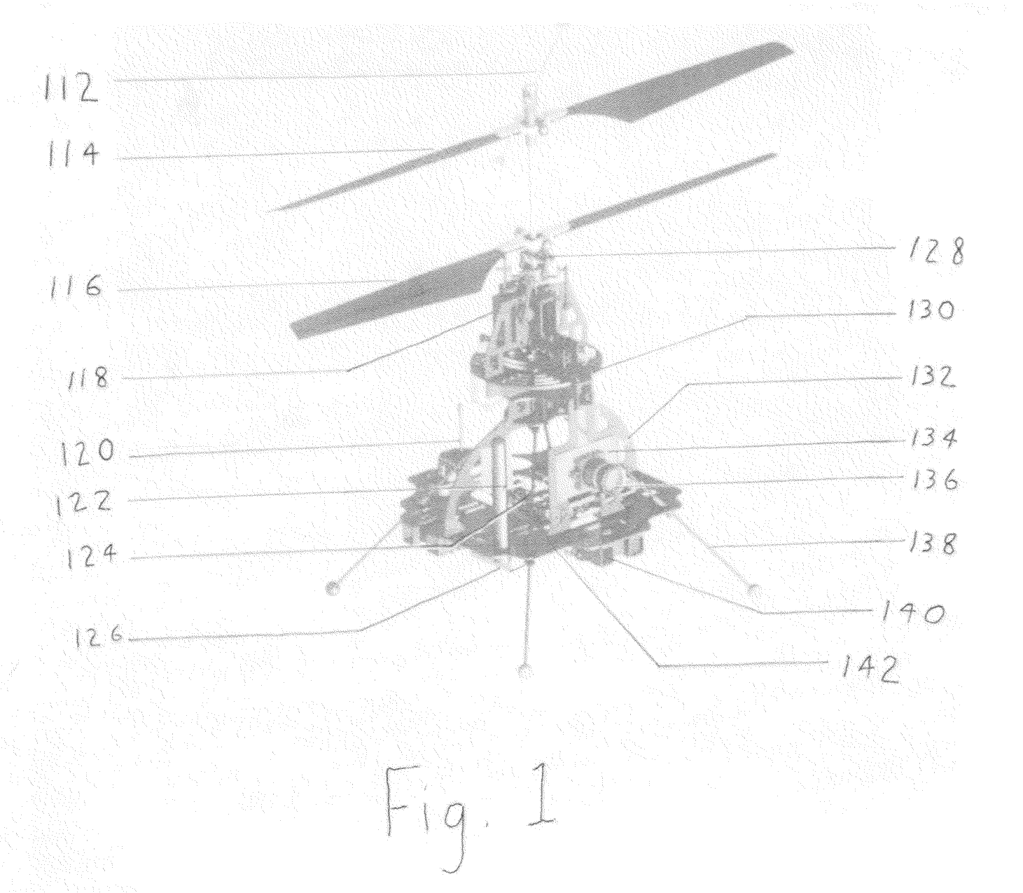

An exemplary drone is depicted in FIG. 1 and includes a stabilizer bar 112, upper rotor 114, lower rotor 116 and servo motor 118. In an embodiment, the drone may have three, four or six rotor/servo motor sets. The drone includes a communication antennae 120, motor module 122, main circuit board 124, battery 126, swash plate 128, brushless motor 130, Wi-Fi module 132, support structure 134, camera 136, skids 138, lateral range finder 140 and sonic module 142. Such a drone is sold as the Skybotix CoaX Autonomous UAV Micro Helicopter Drone

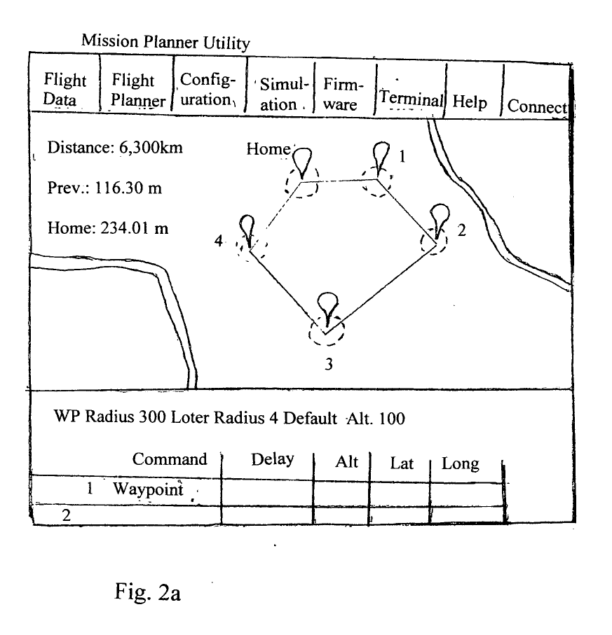

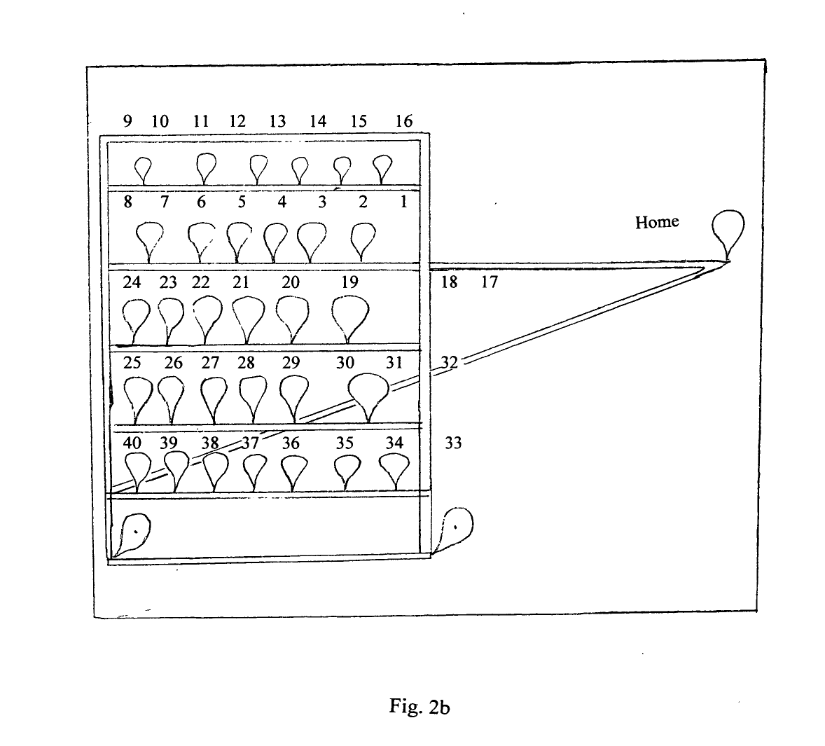

In an embodiment the drone is computer controlled and includes GPS mapping software so that the drone may be controlled and sent to specified addresses on a map, such as an Arducopter. As shown in FIG. 2a the drone includes a mission planner which provides for point and click waypoint entry using Google maps so that the drone may be programmed to fly to specific weigh points programmed in the mission planner and hover at that weigh points 1, 2, 3, 4 (FIG. 1) which in a preferred embodiment would be a business or person's home or address so that the drone equipped with a video camera or still photographic camera can take photographs or video of particular points of interest at a business or home.

In an embodiment the UAV will have the following features:
6 Degree of Freedom IMU stabilized control
Gyro stabilized flight mode enabling acrobatics
GPS for position hold
Magnetometer for heading determination
Barometer for altitude hold
IR sensor integration for obstacle avoidance
Sonar sensor for automated takeoff and landing capability
Automated waypoint navigation
Motor control using low cost standard PWM Electronics Speed Controllers (ESC's)
On board flight telemetery data storage
Mounted camera stabilization capability
Wireless command & telemetry for long distance communication
Capability to fly in “+”, “×”, hexa and octo configurations
Battery level detection
User configurable LED flight pattern
Capability to use any R/C receiver
Configuration and Ground Control Software
   Realtime graphs of flight data
   GUI for configuration of PID and other flight parameters
   On Screen Display integration
   Waypoint programming using Google Maps
   Mixertable view to auto configure “+”, “x”, hexa and octo configurations

Software Roadmap
Initial baseline software
   Provides absolute angle PID flight control
   Obstacle avoidance
   Waypoint navigation
Generalize basic functions (ie. Separate PPM receiver input and motor control functions into separate libraries. Allows future coding of PWM vs. I2C ESC's)
Emphasis on developing new capability into easy to use C++ libraries
Integrate user defined EEPROM storage capability
Develop/optimize serial real-time command/telemetry
Configurator for external software configuration
Configurator to Ground Control Station and integrate graphical programming of waypoint navigation
Rate PID control
Mixertable configuration for multicopter configurations
Camera stabilization
I2C motor control
Wirelessly control directly from Ground Control Station (USB joystick controller from laptop or through waypoint programming)

Using an unmanned aerial vehicle/drone including features provided above, such an ArduCopter or AeroQaud, data can be collected regarding the current condition of buildings, homes, automobiles, landscaping and power lines using a camera on the drone. For example a digital still and video camera may be mounted to the drone, such as a GoPro HERO3 or other device providing video resolutions up to 1080p30, 5 MP photos up to 3 frames per second, an ultra wide angle lens and built-in Wi-Fi. The drone is programmed to fly to specified street addresses from a data base linked to GPS mapping software to automatically allow the drone to find the location and to drop from a transit altitude of 200 feet to 50 feet for surveillance. The drone can take photos using a telephoto lens to photograph features of a building (such as roofing shingles, gutters, windows, driveways, trees, power lines, automobile license tags etc.) and downloading the images and labeling the image according to the street address. The data is wirelessly transmitted to a land based computer system where the photographs may be compared to templates so that analysis may be undertaken automatically from the photos. So for example, the photos of the roof of a home will show the details of the condition of the roofing shingles. The photos may be compared to photos of new roofing shingles of a similar type and color so that computer analysis may be undertaken to determine whether the roof needs repair or replacing. The computer will then use the photo to determine the square footage of the roof and automatically generate a quote for the work to be completed for the home or business and the data base will pair the quote with the address of the property and automatically send mail to that address providing the quote with photos of that parties roof. Similar sequences of processing photo data to provide sales leads may be undertaken for landscaping services such as lawn cutting, tree trimming, fixing gutter, cleaning gutters, repairing chimneys, grouting for brick, caulking windows and asphalt repair for driveways. Similar services can be provided for insurance companies for inspection of properties after a storm to help with repair and to prevent fraudulent claims. The drone would be equipped with altitude sensors, gyroscope, GPS tracking, power consumption sensor, battery power, propellers, landing gear, video and still photo components, vibration adjustment components, radio control transmitters and solar cells.

The drone system includes a full ground station (“Home” FIG. 1) for monitoring missions and sending in-flight commands. Based on the feedback of video and photographic images sent back from the drone to the computer connected to the drone, modifications in the flight plan may be made. For example, if particular issues are found at the business or home being monitored at the weigh point, the mission may be expanded to explore other areas and take additional photographs and video.

In an embodiment, the drone may be used assist the local electric company such as Commonwealth Edison in determining when power lines have trees and other vegetation too close or growing on the power lines that need to be trimmed. The drone can take photos or videos of the power lines running to and from a building and the images may be sent back to a computer for analysis and pinpointing areas that need trimming. Software analysis programs may be provided to analyze the images to identify automatically the areas where the vegetation is growing onto the power lines. The software will highlight the exact location using latitude and longitude and GPS coordinates to identify the area where the trimming needs to be done. In this way, trimming crews will not waste time trying to locate the power lines that have vegetation. That will be done in advance and the trimming crew can go directly to the properties and addresses where the overgrown power lines are located. As well, the software can help identify the easiest route via roads for access to the power lines for the trimming. In this way, the process of locating the power lines that have overgrown vegetation can be handled solely by the drones and expensive labor for human beings need not be expended for that portion of the task. The human labor need only be deployed in order to trim the vegetation surrounding the power lines.

In another embodiment, the drone may be used to identify roofing materials that are worn out. The drone may fly over a pre-determined neighborhood and be programmed to fly over every house in a specific neighborhood and take photographs or video at each home of the roof and roofing materials. The data for each individual home will be downloaded to the computer and stored where each address according to a map such as Google Maps has its own file in which the video or photographs are stored and analyzed. The software will automatically analyze the images of the roof and be able to identify when the roofing materials are worn out and need replacement or repair. As the address of the property is already part of the file, the software system can automatically generate a letter or email if the email address can be located to send to the property owner and identify the repair that is needed. In addition, the software will automatically generate a quote depending on the size of the roofing materials, the size of the roof and the cost of the roofing materials. The video or photographs can be analyzed by the software to approximate the square footage of the roof surface of the building so that the estimate may be prepared based on the specific size of the building. This data may be sold to local roofing companies so that they may add the addresses in need of roof repairs to their marketing and sales contact systems. In this way, the time of the roofing company personnel can be spent solely in repairing roofs and not conducting canvassing to identify roofs that need repair and/or preparing quotes.

In an embodiment cadastral applications tachymeter and Gobal Navigation Satellite Systems (GNSS) may be used to survey object points. Good and appropriate flight planning may be used for the a UAV method of acquisition of geodata. Such systems such as Leica TPS System 1200 may be used having orientation 0.3 mgon and distance of 2 mm and 2 ppm or a 3D coordinate Quality 2-3 cm: Cadastral maps may be generated and datasets verified using the tachymetry method using measurements of parcel boundary lines or main roads compared to GNSS data or Google maps data. 3D coordinate systems may be used and generated by the drone database to generate images of the pertinent property being targeted. Photogrammetric evaluation software such as LPS Stereo analysis of such images may allow for identification of anomalies, vegetation or repair work needed. Exporting image data to a photo model or software can aid in better visualization.

In an embodiment, the drone may be fitted with heat seeking sensors or a camera that has heat emitting imaging capability. The drone camera can focus its field of vision on windows or doors of a building to identify heat leakage during the winter. Software can be calibrated to compare heat leakage data from a particular building with standard heat leakage to determine excessive readings so that defective or old windows or doors at a location may be identified. Likewise cool air sensors may be used to identify defective doors or windows during the summer that leak conditioned air. The data collected from these drone collections could be provided to window or door manufacturers to aid in sending targeted quotes that identify the savings a property owner could obtain by installing new doors or windows based on the particular excessive heat loss from that particular building. Such data cold assist the government in determining what level of subsidies it may need to provide for specific geographic areas to improve energy consumption and by electric companies to predict energy savings for retrofitting and improvements to properties.

In another embodiment the drone may be used to aid insurance companies in estimating damages of property following a storm or earthquake. A period such as a day after a storm has hit an area a multiple groups of drones will be deployed to canvas the area in which the storm hit in order to take pictures and photographs of the damaged areas. For example, a truck may be provided that is a launching pad for multiple drones. A standard work van may be modified so that the roof has mounted thereon launching pads for at least eight drones. Inside the van can be included a ground station including multiple monitors and computer equipment with video displays to operate the drones and coordinate the retrieval of the data.

The drone launch vehicle is driven to the affected area using waypoint software such Arducopter Autopilot open source software available at http://code.google.com/p/arducopter/. The drone is controlled using the Mission Planner Utility (MPU) as depicted in FIG. 2a. The MPU provides Flight Data module, Flight Planner module, Configuration module, Simluation module, Firmware module, Terminal module and a Connect module. Preprogrammed waypoints can be planned according to Delay time at each waypoint, altitude, latitude and longitude. So for example, as shown in FIG. 2a the waypoints Home, 1, 2, 3, 4 may be preprogrammed for providing surveillance of particular properties.

In an embodiment depicted in FIG. 2b, the drones may be programmed to fly from Home base and fly over every home in a neighborhood and take video and photographic images of each property 1-40 (FIG. 2b) and download a file which is assigned an address based on Google Map Data for each property 1-40. The downloaded image file is analyzed by software to analyze the data to identify anomalies such as broken windows, holes in the roofs, worn shingles, falling trees, damaged automobiles, broken swimming pools, broken concrete, or any other unusual damaged property. The software is programmed to compare template images of proper components and compare with the gathered images in order to identify the size of the holes or fractures to buildings and the size of trees that have fallen etc. The software can estimate damages based on the size of the holes and other damage to the property using surface texture analysis (STA), Gaziru or VisionIQ. In another embodiment composite images from video streams such as disclosed in US patent publication no. 2006/0028549, which is incorporated herein by reference.

This data can be immediately sent back to insurance companies so that overall estimates of complete damaged properties of the insured can be obtained quickly to estimate the overall effect on the potential payout an insurance company may have to make due to a particular storm. As well, because the drones can capture the data within days after the storm, any further modification or claims made that don't match the photographic or video data gathered from the drones can be used to determine when fraud or abuse of insurance policies is occurring. Therefore, the deployment of the drones can save insurance companies significant money by reducing the fraud and fraudulent claims being made.

In a further embodiment, the drones can be used to identify anomalies with buildings which violate zoning codes. The drones may be programmed to fly over a city and photograph and video specific areas of a city and download the data showing the location of the building boundaries with respect to sidewalks and streets. The data may then be compared to computer generated mapping of zoning and plat boundary data. By making comparisons of the actual physical location of the structures with the zoning and plat boundary data, anomalies may be identified. For example, if a building owner has built beyond the zoned area, the software can identify such anomalies so that the municipal body may take action with respect to such anomalies

Further embodiment of the invention may be used where drones help farmers identify crops which are suffering or need additional attention. The drone may be programmed to fly over specific acreage on a farm and take photographs and videos of particular crops. The videos and photographs may be analyzed via computer software programs to identify irregularities in the crops in a particular field. Through such analysis, the farmer may be warned in advance of issues such as needing additional water or drainage from particular parts of the field. As well, the images may be used to identify when harvesting should occur and the crops in the field are mature and ready for harvesting.

For each of these applications, the drone can be programmed never to drop below 50 feet above the earth. In this way, the drone cannot drop to a level in which it will be parallel with a standard building window and cannot invade the privacy of the occupant of the building or home. The drones will be programmed solely to take videos and photographs looking downward into public spaces and not into private areas within a person's home or building. Therefore, the drone can be excluded from privacy violations.

However, the drone can have video and photographic equipment that can zoom in on and locate human movement in open spaces on the ground. So another use of the drone may be to identify criminal activity. For example, a drone may be programmed to circle a large parcel of land such as a golf course to detect improper entrance to the golf course or other land during hours when the area is closed. By hovering continuously over the golf course and having cameras that can identify human movement, the drone can be programmed to automatically move toward the area where human is occurring and focus the video camera or photographic camera on the human movement in order to focus in on the human object and get detailed photos or videos of the person's face. Facial recognition or biometric facial recognition technology such as Identix or FaceIt can be used. The data can be stored and returned to security personnel or policemen.

In another embodiment, the drone may be used to protect national borders and to identify the movement of individuals across the borders illegally.

A further embodiment of the invention is used for sporting events. For example, a drone may hover over the goal posts at the end of a football field and videotape the football team on the field. It is common for high school teams to have a video camera in the booth on the 50 yard line and take pictures and video of the team for later analysis. However, the view from the 50 yard line does not expose all the lanes that are created by the lineman of the football team and a view from the end zone is more appropriate for seeing those lanes and seeing more movement on the football field. Thus, it would be helpful to have a video camera positioned in the end zone looking down on the field. The drone can be programmed to focus in on specific movement of the football players and react when the ball is hiked and videotape continuously the movement of the football players throughout the course of a football game.

As with all of the above embodiments, the drone may be programmed in advance using weigh points and simultaneously be controlled with a radio control transmitter so that real time manipulation and control of the drone may occur based on particular operation of the drone that is desired. In an embodiment, the drone will provide real time video feedback at the ground station to display monitors or computers so that the images being photographed or videoed by the drone are seen on the video display at the control station. Therefore, zooming in or zooming out or movement of the drone in order to capture different angles or views can be accomplished through the radio control unit.

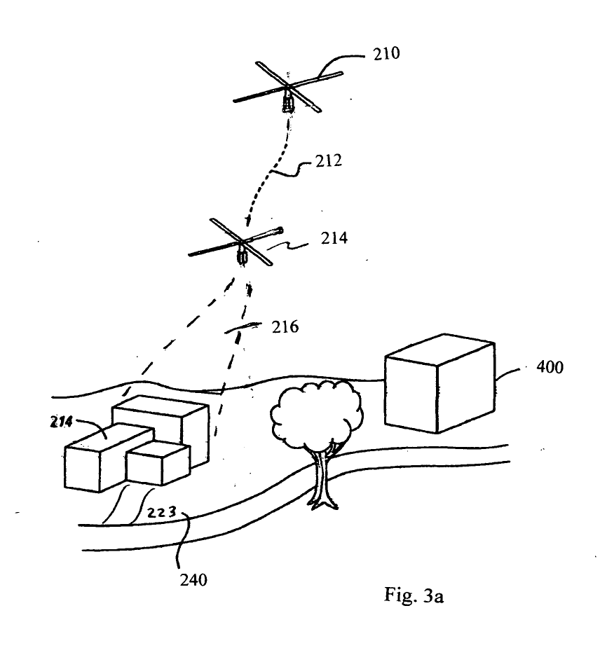

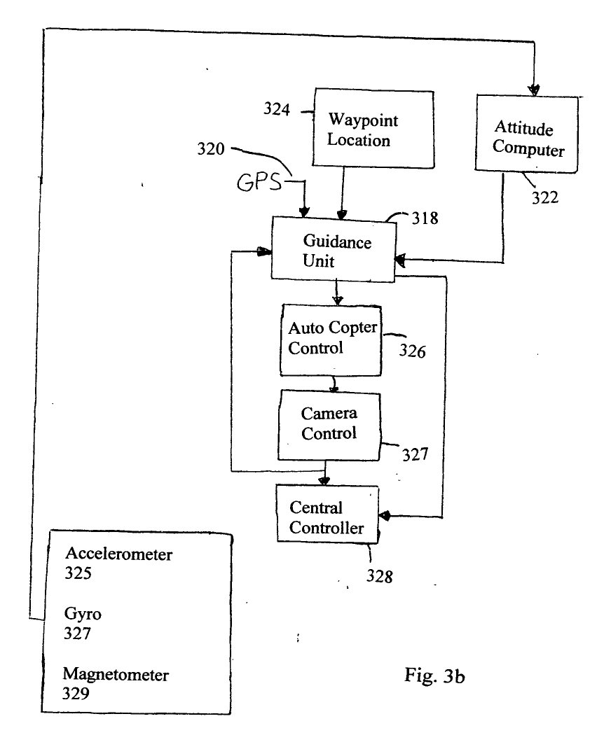

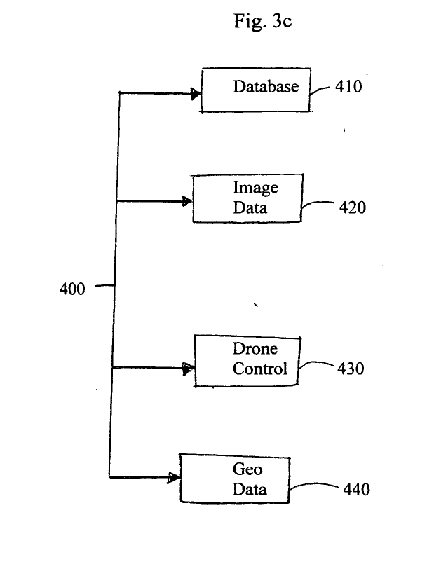

In an embodiment as shown in FIG. 3a-c data collection system includes an unmanned aerial vehicle (UAV) or drone 110 having a micro-processor for managing control of the UAV. As shown in FIG. 3b the UAV is managed by a guidance unit 318 linked to an auto copter control/UAV 326 and camera control 327. These are linked by central controller 328 that includes transmitting and receiving antennae to send and receive data. The Guidance unit controls the attitude computer 322 that links to an accelerometer 325, gyro 327 and magnetometer 329. The guidance unit links to a waypoint location unit 324 that receives GPS 320 and geo data from the ground control computers 200 (FIG. 3a).

These controls operate the UAV, as depicted in FIG. 3a, so that it may have an automatic route programming to a particular waypoint where descends along path 212 to designated surveillance position 214 so that the camera has a field of view 216 of the target property 214. The system includes a ground station 400 for controlling the UAV and a computer system including servers, data base and main computer 110 and output monitors for receiving image data from the UAV and camera. The ground station 400 as depicted in FIG. 3c includes a first computer media 420 for collecting image data, a second computer media included with the main computer 410 for analyzing image data and locating anomalies in the image data, a third computer media for linking particular image data to address and geo data 440; a drone control module 430 that may include radio control unit linked thereto and a fourth computer media with the main computer 410 for generating a list of pertinent properties having similar anomalies by address. The system may include the address data is obtained from Google maps or other internet mapping database to provide the street address 240 that correlates with the latitude/longitude or GPS coordinates of the UAV 214.

In an alternate embodiment the drone will act as a scout for a long haul truck (6 wheeler) that is controlled by the driver via voice control and can scout ahead for bridges and use its camera to scan bridge maximum weights and scout out other obstacles and report in real time. Drone can see if weigh stations are open and look for gas stations and check prices. Due to increased fuel prices and worsening infrastructure trucks waste time and resources going around obstacles and need the drone to help avoid obstacles and save fuel costs. Drone camera can transmit back to in dash monitor on truck.

In a further embodiment, a group of properties may be selected for scheduled surveillance and image data is collected by the drone and received by the database and categorized by maintenance category and date. So for example, a landlord that owns properties 1-4 (FIG. 2a) can hire the drone to monitor whether gutters are being cleaned on a regular basis, whether the asphalt on the driveway is being maintained, how many cars are normally parked in the driveway or bushes are being trimmed on a regular basis. By categorizing and collecting image data by maintenance type a landlord can remotely monitor its property. As well, such data could be provided to a brokerage company to use to determine if regular maintenance was conducted on a property to enhance a sale (similar to a Car Fax for an auto sale). Governments and municipalities could also use such maintenance image data to monitor its properties and to track building code violations and existing residences or during construction.

What is claimed is:

1. A data collection system comprising:
an unmanned aerial vehicle (UAV) having a micro-processor for managing control of the UAV and transmitting and receiving data and a camera;
a ground station for controlling the UAV;
first computer media for collecting image data from the camera;
second computer media for analyzing image data and locating anomalies in the image data; and
third computer media for linking particular image data to address data.

2. The system of claim 1 further comprising fourth computer media for generating a list of pertinent properties having similar anomalies by address.

3. The system of claim 1 wherein the address data is obtained from Google maps or other internet mapping database.

4. The system of claim 1 wherein the anomalies consist of at least one of vegetation overgrowing power lines, defective shingles on roofs, defective asphalt on driveways, debris in gutters, defective grout on brick, defective caulking on windows, excessive heat or cool air dissipation from windows, overgrown grass, excessive leaves on ground and snow filling driveway or walkway.

5. The system of claim 1 wherein the second computer media may calculate a particular monetary quote for corrective services to correct the anomaly based on the measured anomaly identified from the image data.

6. The system of claim 5 wherein the corrective service consists of at least one of
removing vegetation overgrowing power lines, replacing shingles on roofs, repairing asphalt on driveways, removing debris from gutters, repairing defective grout on brick, repairing defective caulking on windows, determining amount of energy saved by replacing excessive heat or cool air dissipation from windows, mowing overgrown grass, removing excessive leaves on ground and removing snow filling driveway or walkway.

7. The system of claim 1 wherein the UAV is programmed to continuously provide surveillance of a group of properties over a regular period of time and to store image data for the group of properties, the image data categorized by maintenance category and analyzed to determine proper maintenance routines have been followed for a group of properties.

8. The system of claim 7 wherein the maintenance routines are monitored by one of a landlord, municipality, insurance company, brokerage agency or government.

9. A data collection system comprising:
first computer media for collecting image data;
second computer media for analyzing the image data and locating anomalies in the image data;
third computer media for linking particular image data to address data of the property where the anomaly is present; and
fourth computer media for generating a list of pertinent properties having similar anomalies by address.

10. The system of claim 9 wherein the address data is obtained from Google maps or other internet mapping database.

11. The system of claim 1 wherein the anomalies consist of at least one of vegetation overgrowing power lines, defective shingles on roofs, defective asphalt on driveways, debris in gutters, defective grout on brick, defective caulking on windows, excessive heat or cool air dissipation from windows, overgrown grass, excessive leaves on ground and snow filling driveway or walkway.

12. The system of claim 9 wherein the second computer media may calculate a particular monetary quote for corrective services to correct the anomaly based on the measured anomaly identified from the image data.

13. The system of claim 12 wherein the corrective service consists of at least one of
removing vegetation overgrowing power lines, replacing shingles on roofs, repairing asphalt on driveways, removing debris from gutters, repairing defective grout on brick, repairing defective caulking on windows, determining amount of energy saved by replacing excessive heat or cool air dissipation from windows, mowing overgrown grass, removing excessive leaves on ground and removing snow filling driveway or walkway.

14. The system of claim 9 wherein the UAV is programmed to continuously provide surveillance of a group of properties over a regular period of time and to store image data for the group of properties, the image data categorized by maintenance category and analyzed to determine proper maintenance routines have been followed for a group of properties.

15. A method of collecting and classifying comprising the steps of:
collecting image data from an unmanned aerial vehicle (UAV);
analyzing the image data and locating anomalies in the image data;
linking particular image data to address data of the property where the anomaly is present; and
generating a list of pertinent properties having similar anomalies by address.

16. The method of claim 15 further comprising the step of calculating a particular monetary quote for corrective services to correct the anomaly based on the measured anomaly identified from the image data.

17. The method of claim 16 wherein the corrective service consists of at least one of removing vegetation overgrowing power lines, replacing shingles on roofs, repairing asphalt on driveways, removing debris from gutters, repairing defective grout on brick, repairing defective caulking on windows, determining amount of energy saved by replacing excessive heat or cool air dissipation from windows, mowing overgrown grass, removing excessive leaves on ground and removing snow filling driveway or walkway.

18. The method of claim 16 further comprising the step of programming the UAV to continuously provide surveillance of a group of properties over a regular period of time and storing image data for the group of properties, categorizing the image data by maintenance category and analyzing the image data to determine that proper maintenance routines have been followed for a group of properties.

19. The method of claim 16 further comprising the step of launching the UAV from a moving ground vehicle, providing verbal instructions to control the UAV and retrieving image data from the UAV that coordinates the itinerary and routing of the ground vehicle.

20. The method of claim 19 wherein the ground vehicle is a cross country truck and the image data includes at least one of bridge data, traffic data, road construction data and weather data.
